(19) United States
(12) Patent Application Publication
(10) Pub. No.: US 2010/0076948 A1
(43) Pub. Date: Mar. 25, 2010

(54) SYSTEM AND METHOD FOR INTERFACING SEARCH REQUEST AND CORRESPONDING SEARCH RESULT

(75) Inventors: Martin James Smithson, Wherwell (GB); David Wynne Williams, Waterlooville (GB)

Correspondence Address: Schmeiser, Olsen & Watts, 22 Century Hill Drive, Suite 302, Latham, NY, 12110, US

(73) Assignee: INTERNATIONAL BUSINESS MACHINES CORPORATION, Armonk, NY (US)

(21) Appl. No.: 12/206,951

(22) Filed: Sep. 9, 2008

(51) Int. Cl. G06F 17/30

(52) U.S. Cl. 707/706; 707/E17.136

(57) ABSTRACT

A system and associated method for handling a search request and a corresponding search result. A client program interactively receives the search request from a user pursuant to an input configuration that defines a time period within which the user can continue typing a search term. The client program submits the search request to a server program that returns the corresponding search result having a respective suggestion for each extended search term. The client program displays the corresponding search result pursuant to an output configuration that defines a manageable number of suggestions to be displayed and a visual cue that the corresponding search result is partially displayed and that can be selected for full display of the corresponding search result.

### FIELD OF THE INVENTION

The present invention discloses a system and associated method for interfacing a large number of matches in a search result generated for a search request.

### BACKGROUND OF THE INVENTION

Web search requests ordinarily generate too many results to present all results to a user. Conventional interface programs truncate a manageable number of matches out of a search result for display, but because the relevance of a truncated set of the search result to a search term provided by a user depends on a matching and/or sorting algorithm employed in selecting the truncated set, it is very unlikely that the user will find a desired search result in the truncated set. Moreover, because the user receives only a display of the truncated set, the user is unlikely to navigate the search result in its entirety without knowing there are more matches than the truncated set.

Thus, there is a need for a system and associated method that overcomes at least one of the preceding disadvantages of current methods and systems for handling large result sets in web searches.

### SUMMARY OF THE INVENTION

The present invention provides a method for handling a search request and a corresponding search result, the method comprising:

initializing interface configuration of a client program, the interface configuration comprising an input configuration variable SUBMIT_DELAY and an output configuration variable MAX_DISPLAY;

receiving a search term from a user of the client program according to a value of SUBMIT_DELAY, wherein the value of SUBMIT_DELAY denotes a time period within which the user may continue typing characters comprised by the search term;

submitting the search request to a server program to perform a search against a database with the received search term;

obtaining, from the server program, the corresponding search result in response to the search request, said search result comprising at least one suggestion for the search term; and

displaying the obtained search result pursuant to a value of MAX_DISPLAY, wherein the value of MAX_DISPLAY is a maximum number of said at least one suggestion that may be shown in a first display,

wherein said initializing, said receiving, said submitting, said obtaining, and said displaying are performed by the client program.

The present invention provides a computer program product, comprising a computer usable storage medium having a computer readable program code embodied therein, said computer readable program code containing instructions that when executed by a processor of a computer system implement a method for handling a search request and a corresponding search result, the method comprising:

initializing interface configuration of a client program, the interface configuration comprising an input configuration variable SUBMIT_DELAY and an output configuration variable MAX_DISPLAY;

receiving a search term from a user of the client program according to a value of SUBMIT_DELAY, wherein the value of SUBMIT_DELAY denotes a time period within which the user may continue typing characters comprised by the search term;

submitting the search request to a server program to perform a search against a database with the received search term;

obtaining, from the server program, the corresponding search result in response to the search request, said search result comprising at least one suggestion for the search term; and

displaying the obtained search result pursuant to a value of MAX_DISPLAY, wherein the value of MAX_DISPLAY is a maximum number of said at least one suggestion that may be shown in a first display,

wherein said initializing, said receiving, said submitting, said obtaining, and said displaying are performed by the client program.

The present invention provides a computer system comprising a processor and a computer readable memory unit coupled to the processor, said memory unit containing instructions that when executed by the processor implement a method for handling a search request and a corresponding search result, the method comprising:

initializing interface configuration of a client program, the interface configuration comprising an input configuration variable SUBMIT_DELAY and an output configuration variable MAX_DISPLAY;

receiving a search term from a user of the client program according to a value of SUBMIT_DELAY, wherein the value of SUBMIT_DELAY denotes a time period within which the user may continue typing characters comprised by the search term;

submitting the search request to a server program to perform a search against a database with the received search term;

obtaining, from the server program, the corresponding search result in response to the search request, said search result comprising at least one suggestion for the search term; and

displaying the obtained search result pursuant to a value of MAX_DISPLAY, wherein the value of MAX_DISPLAY is a maximum number of said at least one suggestion that may be shown in a first display,

wherein said initializing, said receiving, said submitting, said obtaining, and said displaying are performed by the client program.

The present invention provides a method and system that overcomes at least one of the current disadvantages of conventional method and system for interfacing a search request and a corresponding search result.

### BRIEF DESCRIPTION OF THE DRAWINGS

FIG. 1 illustrates a system performing a web-based search that provides auto-suggestive search results, in accordance with embodiments of the present invention.

FIG. 2 is a flowchart depicting a method for interfacing a search request and a corresponding search result to and from a server program, respectively, wherein the method is performed by the client program of FIG. 1, in accordance with the embodiments of the present invention.

FIG. 2A is a flowchart depicting step 230 of FIG. 2, wherein the client program receives a search term, in accordance with the embodiments of the present invention.

FIG. 2B is a flowchart depicting step 270 of FIG. 2, wherein the client program displays a search result, in accordance with the embodiments of the present invention.

FIG. 3 is a flowchart depicting a method for producing a search result for a search request from a client program, wherein the method is performed by the server program of FIG. 1, in accordance with the embodiments of the present invention.

FIG. 4A illustrates a first screen display of a search result that comprises more suggestions than the value of MAX_DISPLAY, in accordance with the embodiments of the present invention.

FIG. 4B illustrates a second screen display with a highlighted visual cue, in accordance with the embodiments of the present invention.

FIG. 4C illustrates a third screen display when the visual cue is selected, in accordance with the embodiments of the present invention.

FIG. 5 illustrates a computer system used for the client program interfacing a search request and a corresponding search result and for the server program producing the corresponding search result, in accordance with embodiments of the present invention.

### DETAILED DESCRIPTION OF THE INVENTION

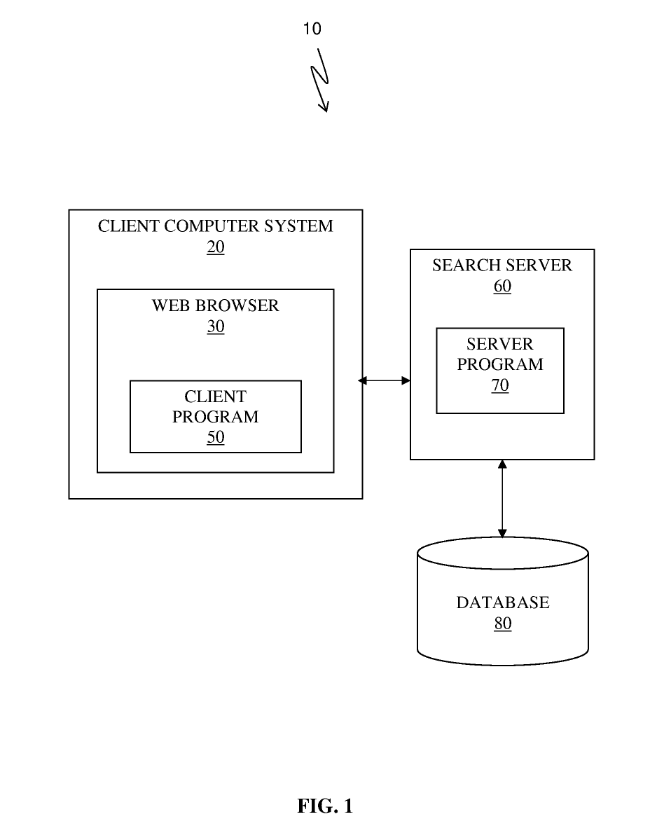

FIG. 1 illustrates a system 10 performing a web-based search that provides auto-suggestive search results, in accordance with embodiments of the present invention. The system 10 comprises a client computer system 20, a search server 60, and a database 80.

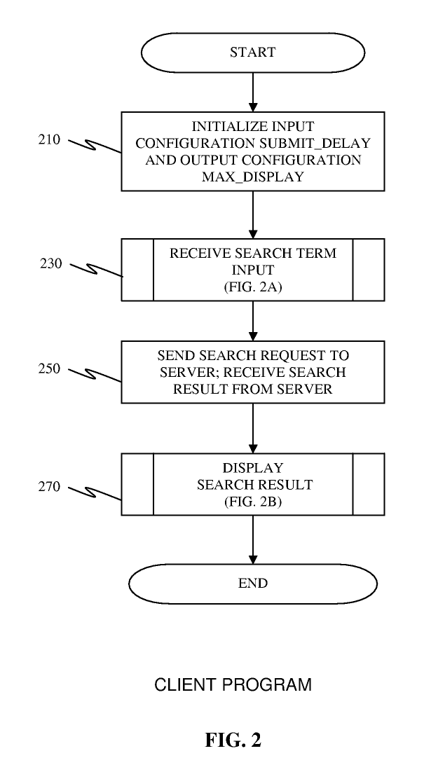

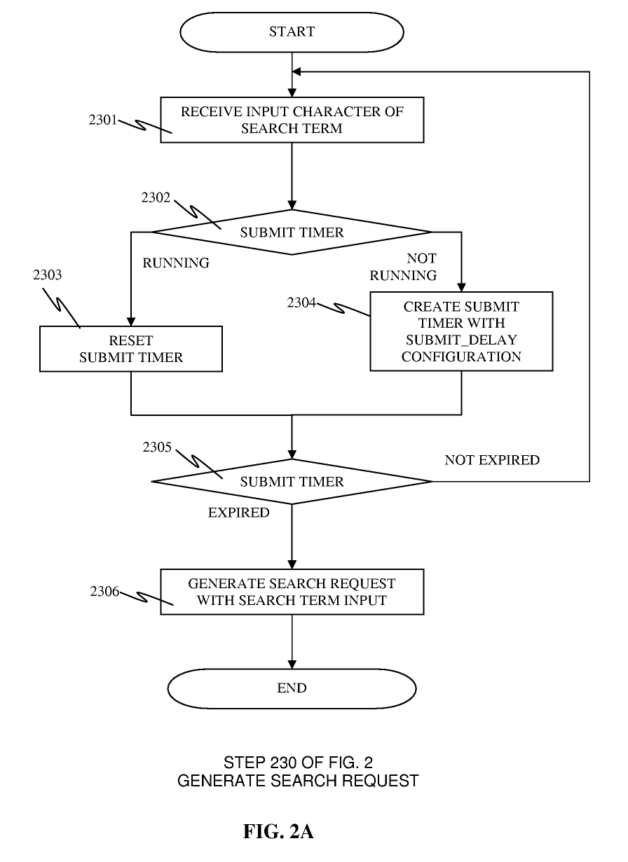

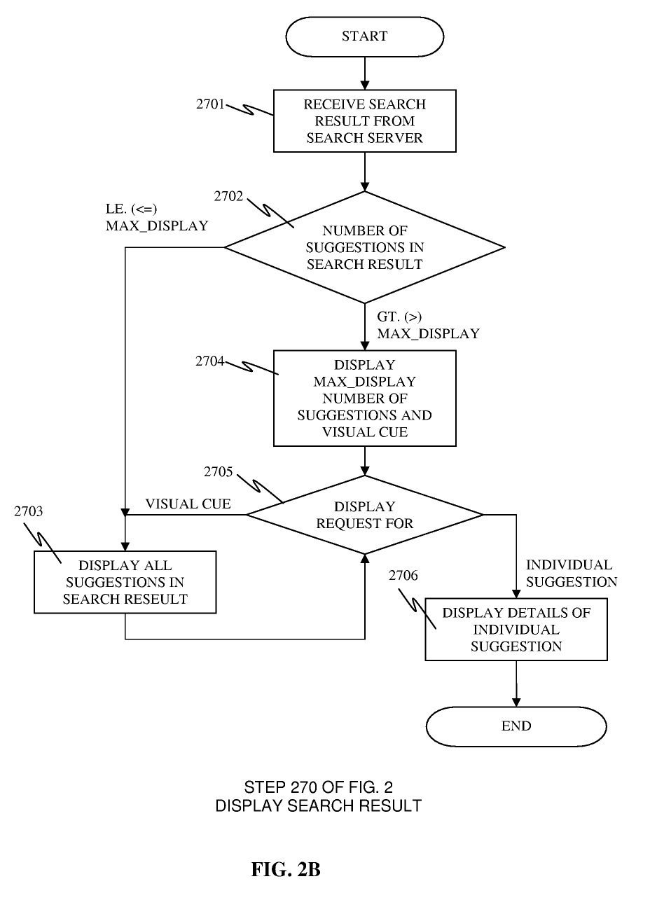

The client computer system 20 comprises a client program 50 that runs in a scripting environment provided by a web browser 30. The client program 50 provides a user interface through the web browser 30 for a search that is performed by the search server 60 against the database 80. See the description of FIG. 2, infra, for details of the client program 50. The client program 50 generates a search request with a search term received from a user. The characters in the search term are received according to input configuration of the client program 50. See the description of FIG. 2A, infra, for details on how the client program 50 generates the search request. The client program 50 sends the search request to the search server 60 and receives a search result produced by the search server 60. The client program 70 displays the search result pursuant to the output configuration of the client program 70. See the description of FIG. 2B, infra, for details on how the client program 50 displays the search result.

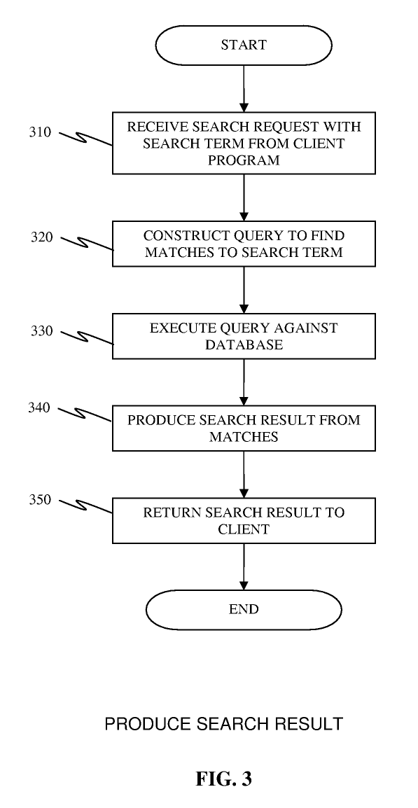

The search server 60 comprises a server program 70 that produces the search result by performing a query against the database 80 and subsequently processing matches to the query. See the description of FIG. 3, infra, for details on steps performed by the server program 70.

The client program 50 and the server program 70 may be written in any scripting language that is supported by the web browser 30, inter alia, JavaScript®, Perl®, PHP, etc. (JavaScript is a trademark of the Sun Microsystems, Inc. in the United States and/or other countries; Perl is a trademark of the Perl Foundation in the United States and/or other countries). Conventional auto-suggest search utilizes the Asynchronous JavaScript and XML (Ajax or AJAX) techniques.

FIG. 2 is a flowchart depicting a method for interfacing a search request and a corresponding search result to and from a server program, respectively, wherein the method is performed by the client program of FIG. 1, supra, in accordance with the embodiments of the present invention.

In step 210, the client program initializes an input configuration variable and an output configuration variable. The input configuration variable SUBMIT_DELAY indicates a period of time in the millisecond unit within which a user can continue typing a search term before the client program submits the search request for the search term to the server program. If the user pauses for a period of time longer than the value of SUBMIT_DELAY, the client program submits the search term. See the description of FIG. 2A, infra, for the usage of SUBMIT_DELAY. In one embodiment of the present invention, SUBMIT_DELAY has an initial value of 300 milliseconds.

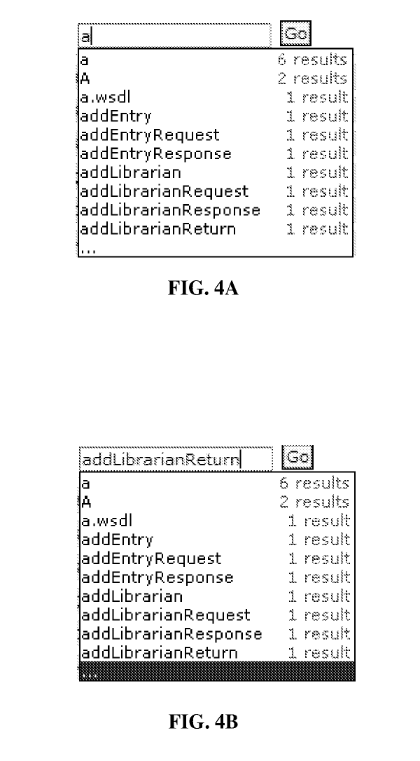

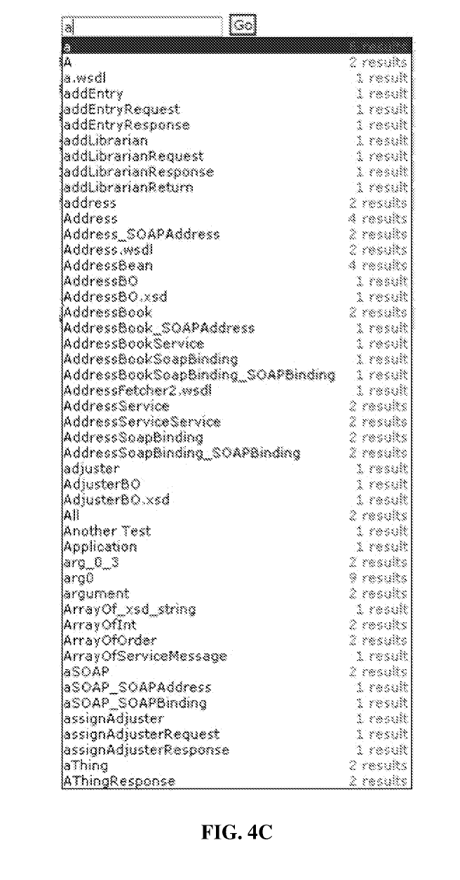

The output configuration variable MAX_DISPLAY indicates the number of matches in the search result that the client program displays in a single page. See the description of FIG. 2B, infra, for the usage of MAX_DISPLAY. In one embodiment of the present invention, MAX_DISPLAY has an initial value of 10, which indicates that the client program displays 10 matches with the search term as a drop down menu from a text entry field that a user enters the search term in the client program. See the description of FIG. 4A, infra, for a displayed result example.

In step 230, the client program interactively receives the search term from the user according to the input configuration variable SUBMIT_DELAY. See the description of FIG. 2A, infra, for details on step 230.

In step 250, the client program sends the search request and the search term to a server program running on the search server. See the description of FIG. 3, infra, for steps performed by the server program. Subsequently, the client program receives the search result that is produced by the server program.

In step 270, the client program displays the search result according to the output configuration variable MAX_DISPLAY. See the description of FIG. 2B, infra, for details on step 270.

FIG. 2A is a flowchart depicting step 230 of FIG. 2, supra, wherein the client program receives a search term, in accordance with the embodiments of the present invention.

In step 2301, the client program receives an input character of the search term through a text entry field on a web page.

In step 2302, the client program determines whether a submit timer is running. If the client program determines that the submit timer is running, the client program proceeds to step 2303. If the client program determines that the submit timer is not running, the client program proceeds to step 2304.

In step 2303, the client program resets the submit timer to a value of the input configuration variable SUBMIT_DELAY. The submit timer was running prior to step 2303. By resetting the submit timer to the SUBMIT_DELAY value, the client program extends a time period for a user to type another input character into the search term.

In step 2304, the client program creates the submit timer with the value of the input configuration variable SUBMIT_DELAY. The submit timer was not running prior to step 2304, which indicates that the input character received in step 2301 is the first character of a new search term. Once the client program creates the submit timer, the submit timer starts running.

In step 2305, the client program determines whether the submit timer has expired. If the client program determines that the submit timer has expired, the client program proceeds with step 2306. If the client program determines that the submit timer has not expired yet, the client program loops back to step 2301 to receive a next character in the search term.

In step 2306, the client program generates a search request from the search term comprising characters received in iterations of step 2301. The submit timer has expired prior to step 2306, which occurs when the user pauses typing characters into the text field for a time period longer than the SUBMIT_DELAY value. The client program recognizes the pause as a completed input of a search term. The client program then proceeds with submission of the search term to the server program in step 250 of FIG. 2, supra.

FIG. 2B is a flowchart depicting step 270 of FIG. 2, supra, wherein the client program displays a search result, in accordance with the embodiments of the present invention.

In step 2701, the client program receives the search result from the server program. The search result is produced by the server program per search request. See descriptions of FIG. 3, infra, for details.

In step 2702, the client program examines the number of suggestions in the search result. If the client program determines that the number of suggestions in the search result is less than or equal to the value of the output configuration value MAX_DISPLAY, then the client program proceed to step 2703. If the client program determines that the number of suggestions in the search result is greater than the value of the output configuration value MAX_DISPLAY, then the client program proceed to step 2704.

In step 2703, the client program displays all suggestions in the search result either because the number of suggestions is manageably small as configured in MAX_DISPLAY or because a display of all suggestions in the search result is specifically requested through a click on the visual cue in a previous step. Then the client program proceeds with step 2705 to receive display request for an individual suggestion.

In step 2704, the client program displays suggestions in the number of MAX_DISPLAY value and a visual cue. The visual cue indicates that there are more suggestions in the search result that are not shown in a current display of the drop down menu. The visual cue also makes such suggestions selectable for an expanded display of the search result. See FIG. 4C, infra, for an example of the expanded display.

In step 2705, the client program receives a display request through an input device that selects an individual suggestion or the visual cue. If the display request is made on an individual suggestion, the client program proceeds with step 2706. If the display request is made on the visual cue, the client program proceeds with step 2703 to expand the drop down menu display for all suggestions in the search result.

In step 2706, the client program displays details of the individual suggestion on which the display request was made. Details of the individual suggestion may be, inter alia, a web page listing matches found by the server program, a single match, a multimedia file, etc. Steps 2705 and 2706 may be repeated for each suggestion in the search result.

FIG. 3 is a flowchart depicting a method for producing a search result for a search request from a client program, wherein the method is performed by the server program of FIG. 1, supra, in accordance with the embodiments of the present invention.

In step 310, the server program receives the search request with the search term from the client program performing step 250 of FIG. 2, supra.

In step 320, the server program constructs a query for the search request from the client program. The query is in any query language that can be executed against the database to be searched. Examples of query languages for the query may be, inter alia, XPath, Structured Query Language (SQL), etc. To find the most matches for the search request, the query uses wildcard extensions for the search term. The query also does not distinguish characters in the search term according to their cases.

In one embodiment of the present invention, the query is in the XPath format. The XPath query “//*[matches(@name, ‘stock.*’,‘i’)]” is constructed by the server program upon receiving a search term “stock” from the client program. The server program extends the search term with wildcards “stock.*” in constructing the query in XPath format to return any objects in the database that begin with the search term “stock”. The query in this embodiment is not case sensitive.

In another embodiment of the present invention, the query is in the SQL format. The SQL query “select * from employee where upper (lastname) like upper (‘stock % ’)” is constructed by the server program upon receiving a search term “stock” from the client program. In the SQL query, the search term is extended with wildcards by using the “like” keyword and adding the ‘%’ character to the search term. The upper ( ) function used in the SQL query renders the query as case insensitive to discover the most matches in the database by executing the query.

In step 330, the server program obtains matches as a result of executing the query against the database. The matches obtained are records from the database that comprise case-sensitive keys.

In step 340, the server program produces a search result from the matches obtained in step 330. The search result comprises at least one processed match referred to as a suggestion mapped to a search key. The search key comprises the search term provided by the client program and may further comprise extra characters as extended by the server program.

In one embodiment of the present invention, the search result is processed to generate a unique suggestion for a respective search key in the search result. When the same match is found several times for a search key, the suggestion associated with the search key is modified to indicate the number of matches that were found.

In step 350, the server program returns the search result to the client program. The method of the present invention returns a search result for a search request upon receiving a search term, as opposed to prior art search methods that make multiple search requests for a single search term and receive a corresponding search result per search request.

FIG. 4A illustrates a first screen display of a search result that comprises more suggestions than the value of MAX_DISPLAY, in accordance with the embodiments of the present invention.

The client program displays suggestions in a drop down menu from a text entry field through which a search term was received. In the example, the output configuration variable MAX_DISPLAY is initialized to ten (10) and the number of suggestions produced by the server program is greater than MAX_DISPLAY value. Thus, the client program displays ten suggestions and the visual cue to indicate there are more suggestions that are not displayed in current screen. In this embodiment, the visual cue is an ellipsis (“ . . . ”).

FIG. 4B illustrates a second screen display with a highlighted visual cue, in accordance with the embodiments of the present invention.

In on embodiment of the present invention, when the visual cue is highlighted but not selected, the visual cue flashes briefly before displaying suggestions in the search results. If the visual cue is explicitly selected, the rest of the suggestions in the search result are displayed in an expanded drop down menu.

FIG. 4C illustrates a third screen display when the visual cue is selected, in accordance with the embodiments of the present invention.

The drop down menu is expanded to display all suggestions in the search result, thus visual cue needs not be displayed.

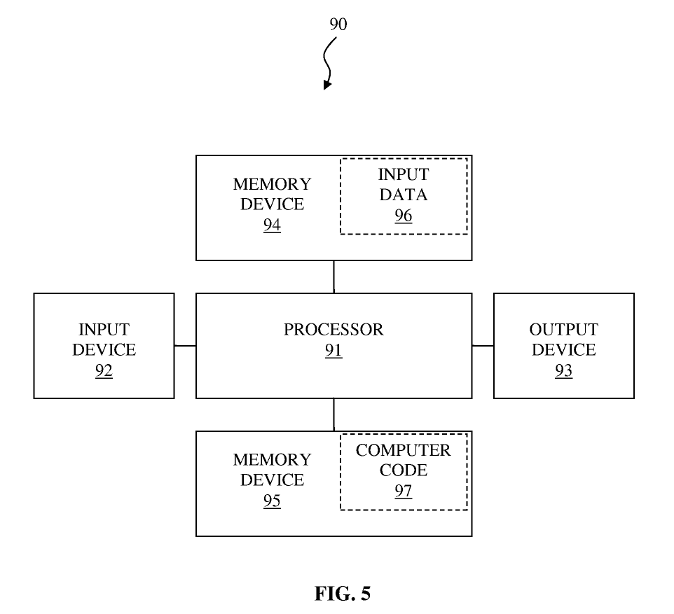

FIG. 5 illustrates a computer system 90 used for the client program interfacing a search request and a corresponding search result and for the server program producing the corresponding search result, in accordance with embodiments of the present invention.

The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, a keypad, a touchscreen, a voice recognition device, a sensor, a network interface card (NIC), a Voice/video over Internet Protocol (VOIP) adapter, a wireless adapter, a telephone adapter, a dedicated circuit adapter, etc. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc. The memory devices 94 and 95 may be, inter alia, a cache, a dynamic random access memory (DRAM), a read-only memory (ROM), a hard disk, a floppy disk, a magnetic tape, an optical storage such as a compact disk (CD) or a digital video disk (DVD), etc. The memory device 95 includes a computer code 97 which is a computer program that comprises computer-executable instructions. The computer code 97 includes, inter alia, an algorithm used for interfacing a search request and a corresponding search result according to the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 5) may be used as a computer usable storage medium (or a computer readable storage medium or a program storage device) having a computer readable program embodied therein and/or having other data stored therein, wherein the computer readable program comprises the computer code 97. Generally, a computer program product (or, alternatively, an article of manufacture) of the computer system 90 may comprise said computer usable storage medium (or said program storage device).

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for handling a search request and a corresponding search result, the method comprising:
initializing interface configuration of a client program, the interface configuration comprising an input configuration variable SUBMIT_DELAY and an output configuration variable MAX_DISPLAY;
receiving a search term from a user of the client program according to a value of SUBMIT_DELAY, wherein the value of SUBMIT_DELAY denotes a time period within which the user may continue typing characters comprised by the search term;
submitting the search request to a server program to perform a search against a database with the received search term;
obtaining, from the server program, the corresponding search result in response to the search request, said search result comprising at least one suggestion for the search term; and
displaying the obtained search result pursuant to a value of MAX_DISPLAY, wherein the value of MAX_DISPLAY is a maximum number of said at least one suggestion that may be shown in a first display,
wherein said initializing, said receiving, said submitting, said obtaining, and said displaying are performed by the client program.

2. The method of claim 1, said displaying comprising:
determining that the number of said at least one suggestion in the search result is greater than the value of MAX_DISPLAY; and
responsive to said determining, presenting, to the user, the first display comprising a number equal to the value of MAX_DISPLAY of suggestions of said at least one suggestion and a visual cue, wherein said visual cue represents that the first display comprises less suggestions than the search result, wherein each suggestion of said at least one suggestion can be selected and expanded with a respective description of each suggestion.

3. The method of claim 1, said displaying comprising:
determining that the number of said at least one suggestion in the search result is less than or equal to the value of MAX_DISPLAY; and
responsive to said determining, presenting, to the user, the first display comprising said at least one suggestion, wherein each suggestion of said at least one suggestion can be selected and expanded with a respective descriptions of each suggestion.

4. The method of claim 1, said initializing comprising:
assigning a value of three hundred (300) milliseconds to SUBMIT_DELAY; and
assigning a value of ten (10) to MAX_DISPLAY.

5. The method of claim 1, said submitting comprising:
determining that a time period specified as a value of SUBMIT_DELAY has elapsed since the user typed the latest character for the search term;
generating the search request with the search term; and
sending the generated search request to the server program.

6. The method of claim 1, said method further comprising:
subsequent to said submitting and prior to said obtaining, the server program services the search request comprising the steps of:
receiving the search request and the search term from the client program;
executing a query against the database, wherein the query is constructed to find at least one respective match for at least one extended search term in the database, wherein each extended search term of said at least one extended search term is a respective extension of the received search term based on a query language used to search the database;
producing the corresponding search result from all matches comprising said at least one respective match for said at least one extended search term, said corresponding search result comprising said at least one suggestion that is associated with each extended search term; and
returning the produced corresponding search result to the client program.

7. The method of claim 6, wherein each suggestion of said at least one suggestion further comprises a respective count of matches for each extended search term of said at least one extended search term.

8. A computer program product, comprising a computer usable storage medium having a computer readable program code embodied therein, said computer readable program code containing instructions that when executed by a processor of a computer system implement a method for handling a search request and a corresponding search result, the method comprising:
initializing interface configuration of a client program, the interface configuration comprising an input configuration variable SUBMIT_DELAY and an output configuration variable MAX_DISPLAY;
receiving a search term from a user of the client program according to a value of SUBMIT_DELAY, wherein the value of SUBMIT_DELAY denotes a time period within which the user may continue typing characters comprised by the search term;
submitting the search request to a server program to perform a search against a database with the received search term;
obtaining, from the server program, the corresponding search result in response to the search request, said search result comprising at least one suggestion for the search term; and
displaying the obtained search result pursuant to a value of MAX_DISPLAY, wherein the value of MAX_DISPLAY is a maximum number of said at least one suggestion that may be shown in a first display,
wherein said initializing, said receiving, said submitting, said obtaining, and said displaying are performed by the client program.

9. The computer program product of claim 8, said displaying comprising:
determining that the number of said at least one suggestion in the search result is greater than the value of MAX_DISPLAY; and
responsive to said determining, presenting, to the user, the first display comprising a number equal to the value of MAX_DISPLAY of suggestions of said at least one suggestion and a visual cue, wherein said visual cue represents that the first display comprises less suggestions than the search result, wherein each suggestion of said at least one suggestion can be selected and expanded with a respective description of each suggestion.

10. The computer program product of claim 8, said displaying comprising:
determining that the number of said at least one suggestion in the search result is less than or equal to the value of MAX_DISPLAY; and
responsive to said determining, presenting, to the user, the first display comprising said at least one suggestion, wherein each suggestion of said at least one suggestion can be selected and expanded with a respective descriptions of each suggestion.

11. The computer program product of claim 8, said initializing comprising:
assigning a value of three hundred (300) milliseconds to SUBMIT_DELAY; and
assigning a value of ten (10) to MAX_DISPLAY.

12. The computer program product of claim 8, said submitting comprising:
determining that a time period specified as a value of SUBMIT_DELAY has elapsed since the user typed the latest character for the search term;
generating the search request with the search term; and
sending the generated search request to the server program.

13. The computer program product of claim 8, said method further comprising:
subsequent to said submitting and prior to said obtaining, the server program services the search request comprising the steps of:
receiving the search request and the search term from the client program;
executing a query against the database, wherein the query is constructed to find at least one respective match for at least one extended search term in the database, wherein each extended search term of said at least one extended search term is a respective extension of the received search term based on a query language used to search the database;
producing the corresponding search result from all matches comprising said at least one respective match for said at least one extended search term, said corresponding search result comprising said at least one suggestion that is associated with each extended search term; and
returning the produced corresponding search result to the client program.

14. The computer program product of claim 13, wherein each suggestion of said at least one suggestion further comprises a respective count of matches for each extended search term of said at least one extended search term.

15. A computer system comprising a processor and a computer readable memory unit coupled to the processor, said memory unit containing instructions that when executed by the processor implement a method for handling a search request and a corresponding search result, the method comprising:
initializing interface configuration of a client program, the interface configuration comprising an input configuration variable SUBMIT_DELAY and an output configuration variable MAX_DISPLAY;
receiving a search term from a user of the client program according to a value of SUBMIT_DELAY, wherein the value of SUBMIT_DELAY denotes a time period within which the user may continue typing characters comprised by the search term;
submitting the search request to a server program to perform a search against a database with the received search term;
obtaining, from the server program, the corresponding search result in response to the search request, said search result comprising at least one suggestion for the search term; and
displaying the obtained search result pursuant to a value of MAX_DISPLAY, wherein the value of MAX_DISPLAY is a maximum number of said at least one suggestion that may be shown in a first display,
wherein said initializing, said receiving, said submitting, said obtaining, and said displaying are performed by the client program.

16. The computer system of claim 15, said displaying comprising:
determining that the number of said at least one suggestion in the search result is greater than the value of MAX_DISPLAY; and
responsive to said determining, presenting, to the user, the first display comprising a number equal to the value of MAX_DISPLAY of suggestions of said at least one suggestion and a visual cue, wherein said visual cue represents that the first display comprises less suggestions than the search result, wherein each suggestion of said at least one suggestion can be selected and expanded with a respective description of each suggestion.

17. The computer system of claim 15, said displaying comprising:
determining that the number of said at least one suggestion in the search result is less than or equal to the value of MAX_DISPLAY; and
responsive to said determining, presenting, to the user, the first display comprising said at least one suggestion, wherein each suggestion of said at least one suggestion can be selected and expanded with a respective descriptions of each suggestion.

18. The computer system of claim 15, said initializing comprising:
assigning a value of three hundred (300) milliseconds to SUBMIT_DELAY; and
assigning a value of ten (10) to MAX_DISPLAY.

19. The computer system of claim 15, said submitting comprising:
determining that a time period specified as a value of SUBMIT_DELAY has elapsed since the user typed the latest character for the search term;
generating the search request with the search term; and
sending the generated search request to the server program.

20. The computer system of claim 15, said method further comprising:
subsequent to said submitting and prior to said obtaining, the server program services the search request comprising the steps of:
receiving the search request and the search term from the client program;
executing a query against the database, wherein the query is constructed to find at least one respective match for at least one extended search term in the database, wherein each extended search term of said at least one extended search term is a respective extension of the received search term based on a query language used to search the database;
producing the corresponding search result from all matches comprising said at least one respective match for said at least one extended search term, said corresponding search result comprising said at least one suggestion that is associated with each extended search term, wherein each suggestion of said at least one suggestion further comprises a respective count of matches for each extended search term of said at least one extended search term; and
returning the produced corresponding search result to the client program.
